(19) United States
(12) Patent Application Publication
(10) Pub. No.: US 2026/0153124 A1
(43) Pub. Date: Jun. 4, 2026

(54) SLIDE RAIL MECHANISM

(71) Applicant: Nan Juen International Co., Ltd., Taoyuan City (TW)

(72) Inventors: Fu-Tien CHANG, Taoyuan City (TW); Feng-Ming CHUANG, Taoyuan City (TW); Chih-Yi LIEN, Taoyuan City (TW)

(21) Appl. No.: 19/399,577

(22) Filed: Nov. 24, 2025

(30) Foreign Application Priority Data
Nov. 29, 2024 (TW) 113146593

(51) Int. Cl. F16C 29/04; F16C 29/10

(52) U.S. Cl. CPC F16C 29/04; F16C 29/10

(57) ABSTRACT

A slide rail mechanism includes a slide rail device having a support frame, and a slide rail assembly including a displacement structure, an auxiliary structure set on the displacement structure, a first rail, a second rail and a third rail. The displacement structure, the auxiliary structure, or the switching structure is installed between the slide rail assembly and the slide rail device, enabling the slide rail assembly to achieve stable movable displacement or convenient operation relative to the slide rail device. The support frame, working in conjunction with the slide rail device, effectively integrates the slide rail assembly, resulting in a synergistic effect.

### BACKGROUND OF THE INVENTION

### 1. Field of the Invention

The present invention relates to a slide rail mechanism, wherein the slide rail assembly is movable relative to the slide rail device.

### 2. Description of the Related Art

With the mature development of the computer industry and cloud technology, the demand for electronic data access is increasing, especially in artificial intelligence (AI), such as ChatGPT, in order to meet the massive information access needs. Modern server equipment consists of multiple server chassis housed within a single server. The server chassis and server rack are connected using a sliding rail structure. For example, a first slide rail is provided on each side of the server chassis, and a second slide rail is provided on each side of the server rack, which is opposite to the first slide rail. A longitudinal slide rail mechanism is fixed at the front end of the first slide rail, so the operator can use the longitudinal slide rail mechanism to drive the first slide rail, causing the first slide rail to move on the second slide rail.

### SUMMARY OF THE INVENTION

The main object of the present invention is to provide a slide rail mechanism, wherein a displacement structure, auxiliary structure or switching structure is installed between the slide rail assembly and the slide rail device, enabling the slide rail assembly to perform stable movable displacement or convenient operation relative to the slide rail device.

Another object of this invention is to provide a slide rail mechanism in which the support frame of the slide rail device effectively integrates the slide rail assembly.

To achieve the above objects, the present invention provides a slide rail mechanism, which comprises a slide rail device and a slide rail assembly, wherein the slide rail device comprises a support frame comprising a first wall, a second wall, a longitudinal wall connecting the first wall and the second wall to form a channel, a first guide surface located on the first wall, a fourth wall extending upwards from the first wall, and a positioning means located on the fourth wall; the slide rail assembly comprises a displacement structure, an auxiliary structure set on the displacement structure, a first rail, a second rail and a third rail, the third rail being relative to the first rail and the second rail being relative to the third rail, the second rail comprising a first unlock feature, the displacement structure comprising a mounting member and at least one first rolling member mounted on a top side of the mounting member, the first rail being fixed to the mounting member, the first rolling member comprising a rolling surface, the rolling surface undergoing rolling displacement on the first guide surface to cause the slide rail assembly to move within the support frame of the slide rail device, the auxiliary structure comprising a first locking feature and a second locking feature so arranged that when the first locking feature is locked to the positioning means, the second locking feature is unlocked to the first unlock feature; or when the second locking feature is locked to the first unlock feature, the first locking feature is unlocked to the positioning means.

Using the aforementioned technical means, the displacement structure, the auxiliary structure, or the switching structure is installed between the slide rail assembly and the slide rail device, enabling the slide rail assembly to achieve stable movable displacement or convenient operation relative to the slide rail device. The support frame, working in conjunction with the slide rail device, effectively integrates the slide rail assembly, resulting in a synergistic effect.

### BRIEF DESCRIPTION OF THE DRAWINGS

FIG. 1 is an assembled three-dimensional diagram of the slide rail mechanism of the present invention.

FIG. 2 is an exploded three-dimensional diagram of the slide rail mechanism of the present invention.

FIG. 3 is an exploded three-dimensional diagram of the slide rail assembly, switching structure, displacement structure, and auxiliary structure of the present invention.

FIG. 4 is a front view of the switching structure locking the slide rail assembly of the present invention.

FIG. 5 is a partial front view of the switching structure locking the slide rail assembly of the present invention.

FIG. 6 is a partial rear view of the switching structure locking the slide rail assembly of the present invention.

FIG. 6A is a schematic diagram of a first embodiment of the displacement structure holding the support frame of the present invention.

FIG. 6B is a schematic diagram of a second embodiment of the displacement structure holding the support frame of the present invention.

FIG. 6C is a schematic diagram of a third embodiment of the displacement structure holding the support frame of the present invention.

FIG. 7 is a front view of the switching structure unlocking the slide rail assembly of the present invention.

FIG. 8 is a partial front view of the switching structure unlocking the slide rail assembly of the present invention.

FIG. 9 is a partial rear view of the switching structure unlocking the slide rail assembly of the present invention.

FIG. 10 is a rear three-dimensional view of the switching structure unlocking the slide rail assembly of the present invention.

FIG. 11 is another rear three-dimensional view of the switching structure unlocking the slide rail assembly of the present invention.

FIG. 12 is a front view of the displacement structure of the present invention driving the slide rail assembly on the slide rail device.

FIG. 13 is a partial front view of the displacement structure of the present invention driving the slide rail assembly on the slide rail device.

FIG. 14 is a partial rear view of the displacement structure of the present invention driving the slide rail assembly on the slide rail device.

FIG. 15 is a partial front view of the auxiliary structure of the present invention positioned on the slide rail device.

FIG. 16 is a partial rear view of the auxiliary structure of the present invention positioned on the slide rail device.

FIG. 17 is a front three-dimensional view of the auxiliary structure of the present invention unlocking the slide rail assembly.

FIG. 18 is a front view of the slide rail assembly of the present invention when extended out.

FIG. 19 is a rear view of the slide rail assembly of the present invention when extended out.

FIG. 20 is a front perspective view of the slide rail device of the present invention, including the fixed rail and the movable rail.

FIG. 21 is a rear view of the slide rail device of the present invention, including the fixed rail and the movable rail.

FIG. 22 is a flowchart illustrating the operation method of the slide rail mechanism of the present invention.

FIG. 23 is a schematic diagram showing the first part of the operating component linkage spring of the present invention fastened to the abutment portion.

FIG. 24 is another schematic diagram showing the first part of the operating component linkage spring of the present invention fastened to the abutment portion.

FIG. 25 is a schematic diagram showing the first part of the operating component linkage spring of the present invention separating from the abutment portion.

FIG. 26 is another schematic diagram showing the first part of the operating component linkage spring of the present invention separating from the abutment portion.

### DETAILED DESCRIPTION OF THE PREFERRED EMBODIMENT

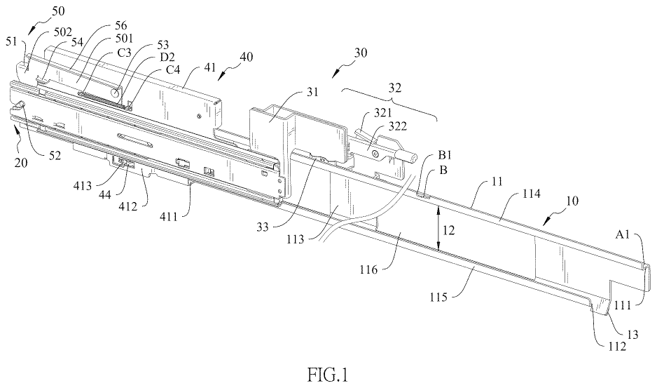

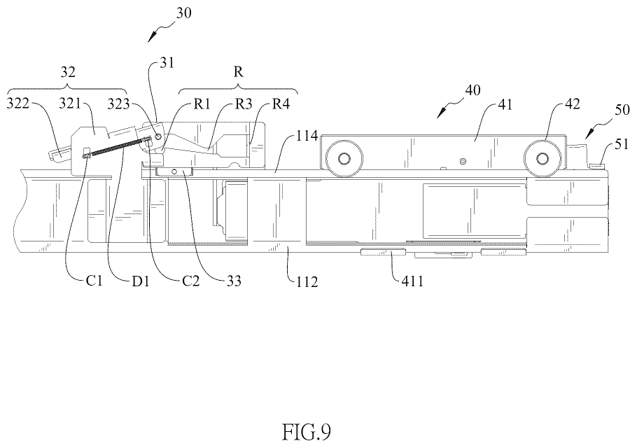

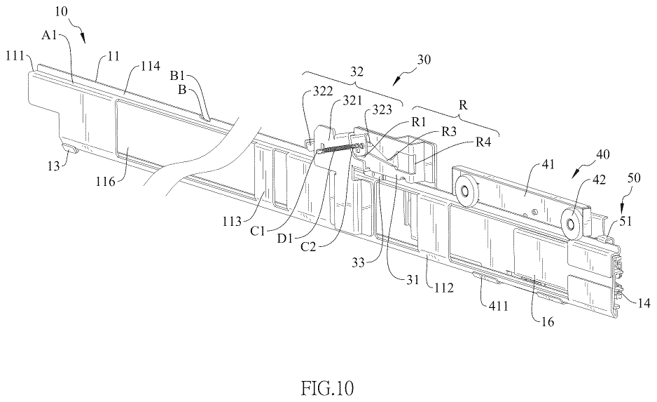

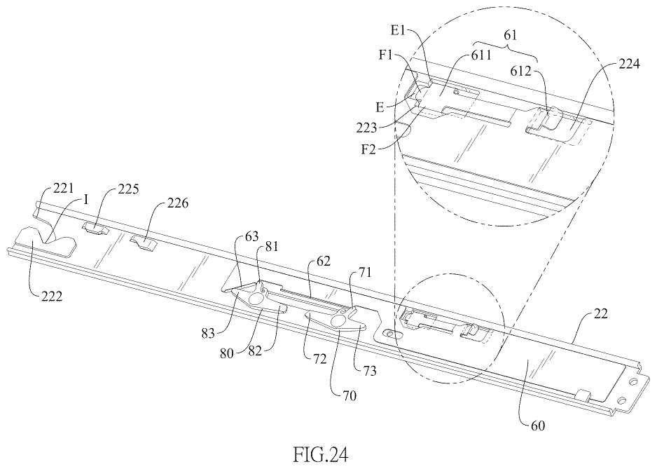

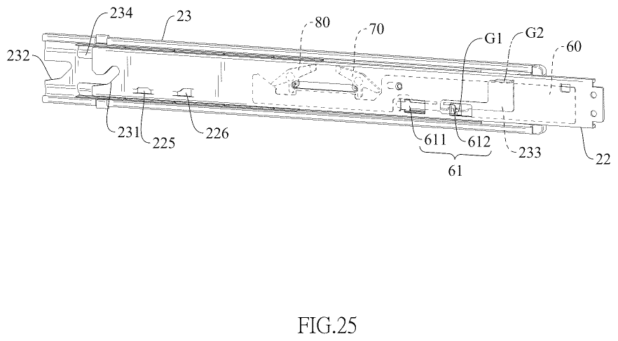

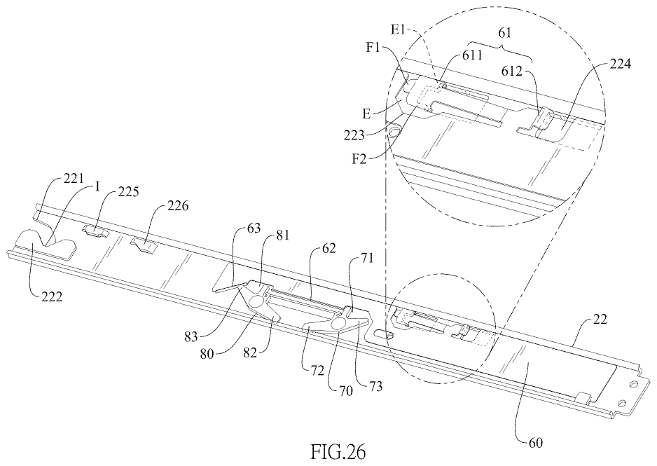

Please refer to FIGS. 1 to 26. The present invention is a slide rail mechanism, comprising: a slide rail device 10 and a slide rail assembly 20. The slide rail device 10 comprises a support frame 11, a switching structure 30, a displacement structure 40, and an auxiliary structure 50. The support frame 11 comprises a first wall 111, a second wall 112, a longitudinal wall 113 connecting the first wall 111 and the second wall 112 to form a channel 12, a fourth wall 114 extending upward from the first wall 111, a fifth wall 115 extending upward from the second wall 112 to form a V-shaped barb shape, a first guide surface A1 provided on the first wall 111, and a notch-shaped positioning means B provided on the fourth wall 114. The slide rail assembly 20 moves within the support frame 11 via the first guide surface A1, and is positioned within the support frame 11 via the positioning means B.

As mentioned above, a first stop 13 is provided at the front of the support frame 11 and a second stop 14 is provided at the rear of the support frame 11, so that the slide rail assembly 20 can be limited between the first stop 13 and the second stop 14.

The switching structure 30 comprises a path plate 31 and a guide device 32 opposite to the path plate 31. One of the path plate 31 and the guide device 32 may be disposed in the slide rail assembly 20 and the other may be disposed in the support frame 11 of the slide rail device 10. When the path plate 31 is located on the slide rail assembly 20, the guide device 32 is located on the slide rail device 10. That is, when the path plate 31 is displaced, the guide device 32 is not displaced and is passively guided. Alternatively, if the path plate 31 is located on the slide rail device 10, then the guide device 32 is located on the slide rail assembly 20. That is, if the path plate 31 does not move, then the guide device 32 moves to provide active guidance. Thus, the slide rail assembly 20 is locked or unlocked in the support frame 11 of the slide rail device 10, and the guide device 32 is locked or unlocked in the path plate 31, so that the slide rail assembly 20 is locked or unlocked in the support frame 11 of the slide rail device 10.

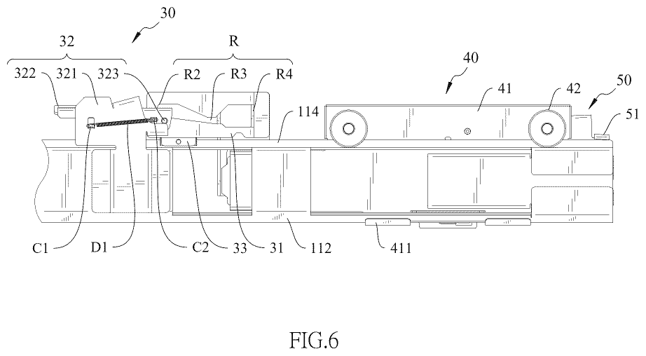

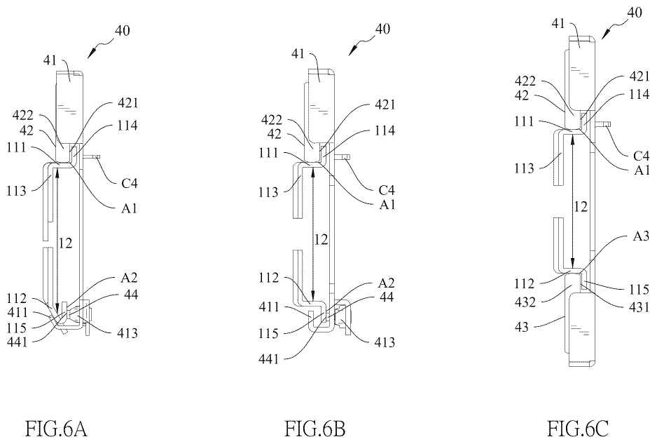

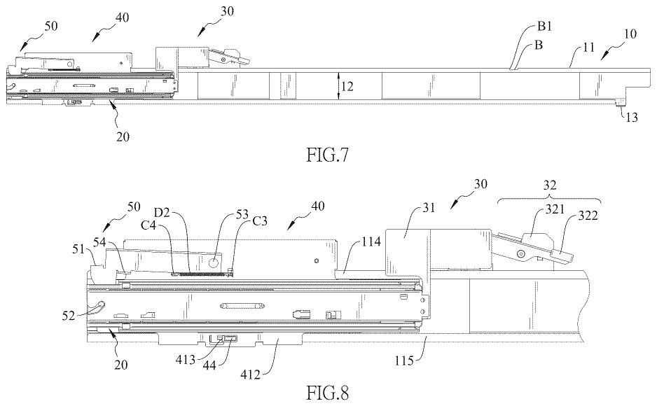

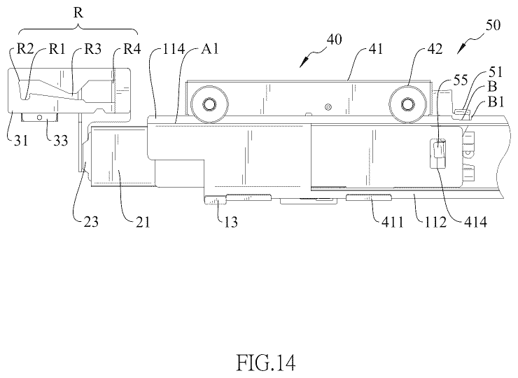

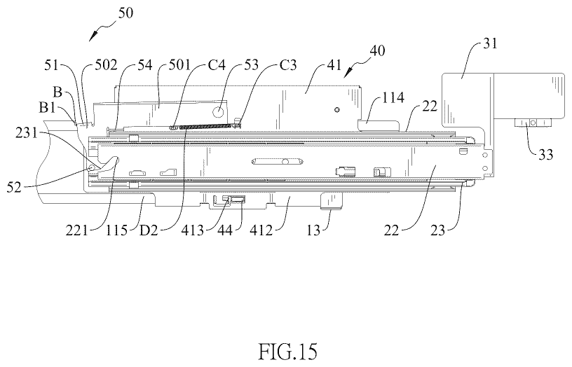

Continuing from the above, the path plate 31 is located on the slide rail assembly 20. The path plate 31 comprises a path R (see FIGS. 6 and 14), which is provided with a locking groove R1, a limiting arc R2, a narrow slit R3, and a differential opening R4. The locking groove R1 extends vertically. The narrow slit R3 is horizontally narrowed between the limiting arc R2 and the differential opening R4, and is positioned on the slide rail device 10 in conjunction with the guide device 32. The guide device 32 comprises a bracket 321, a handle 322 connected to the bracket 321, and a guide block 323 disposed on the handle 322. The guide block 323 is used to move within the path R. During the unlocking process, it passes through the locking groove R1, the limiting arc R2, the narrow slit R3, and the differential opening R4 before leaving the path R. Conversely, during the locking process, the guide block 323 passes through the differential opening R4, the narrow slit R3, and the limiting arc R2 to remain within the locking groove R1. Furthermore, the switching structure 30 can also comprise a guiding feature 33, which can form a wavy guide surface. With the guiding feature 33 relative to the fourth wall 114, the path plate 31 can also be guided, so that the guide block 323 can move smoothly on the path R.

As mentioned above, referring to FIG. 6, a first fixing portion C1 is provided at the end of the bracket 321 away from the connected point between the handle 322 and the bracket 321, and a second fixing portion C2 is provided at the end of the handle 322 near the connected point between the handle 322 and the bracket 321. One end of a first elastic member D1 is connected to the first fixing portion C1, and the other end of the first elastic member D1 is connected to the second fixing portion C2. The elastic force of the first elastic member D1 allows the guide block 323 to smoothly fall into the narrow slit R3 and the differential opening R4 at the limiting arc R2.

The displacement structure 40 comprises a mounting member 41 and at least one first rolling member 42. The first rolling member 42 is installed above the mounting member 41. The rolling surface 422 of the first rolling member 42 rolls and displaces on the first guide surface A1. One side surface 421 of the first rolling member 42 holds the fourth wall 114, and as shown in FIG. 6A, the fourth wall 114 is located between the side surface 421 of the first rolling member 42 and the mounting member 41. In the first embodiment, as shown in FIG. 6A, the mounting member 41 has a holding wall 411 extending obliquely upwardly from the bottom side thereof to hold the second wall 112 of the support frame 11. Regarding the mating structure between the mounting member 41 and the support frame 11, FIGS. 6B and 6C represent the second and third embodiments, respectively. In the second embodiment, as shown in FIG. 6B, the holding wall 411 is provided at the bottom side of the mounting member 41 to hold the fifth wall 115 of the support frame 11, and the fifth wall 115 extends downward relative to the second wall 112 and is connected to the second wall 112 to show an L-shaped cross section. In the third embodiment, as shown in FIG. 6C, compared to the second embodiment, one side surface 431 of each of at least one second rolling member 43 installed at the bottom side of the mounting member 41 holds the fifth wall 115, and the fifth wall 115 is located between the side surface 431 of the second rolling member 43 and the mounting member 41. The second rolling member 43 can roll into contact with the bottom surface of the second wall 112, that is, the side surface 421 of the first rolling member 42 holds the fourth wall 114 and the side surface 431 of the second rolling member 43 holds the fifth wall 115, as if double-holding, so as to achieve stable rolling displacement.

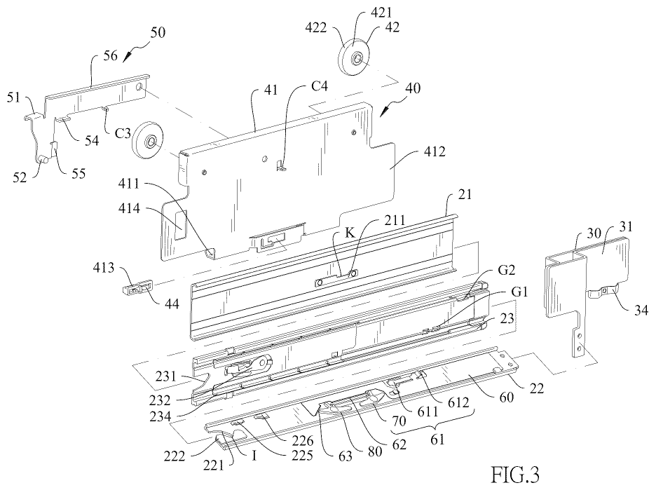

As shown in FIGS. 6A and 6B, the fifth wall 115 comprises a second guide surface A2 for facing the mounting member 41, and the side surface 412 of the mounting member 41 is equipped with at least one third rolling member 44 (see FIG. 3). The rolling surface 441 of the third rolling member 44 rolls and displaces on the second guide surface A2. In FIG. 6A, the fifth wall 115 is folded inward upwards, while in FIG. 6B, the fifth wall 115 is folded outward downwards, or as shown in FIG. 6C. The second wall 112 has a third guide surface A3. The rolling surface 432 of the second rolling member 43 rolls on the third guide surface A3. The first rolling member 42 and the second rolling member 43 are mounted with their rolling axes in a horizontal direction, and the rolling surface 422 of the first rolling member 42 and the rolling surface 432 of the second rolling member 43 are facing each other. In FIGS. 6A and 6B, the third rolling member 44 is installed with its rolling axis in the longitudinal direction, so that the rolling surface 422 of the first rolling member 42 and the rolling surface 441 of the third rolling member 44 are not facing each other. Furthermore, the mounting member 41 can also comprise a holder block 413 for mounting the third rolling member 44, and the holder block 413 can be detached from the mounting member 41.

The auxiliary structure 50 is located between the displacement structure 40 and the slide rail assembly 20, comprising a generally transversely extending first plate 501 and a generally downward extending second plate 502, as well as a first locking feature 51 and a second locking feature 52. The first locking feature 51 and the second locking feature 52 are disposed on the second plate 502, and the second locking feature 52 is located below the first locking feature 51. The first locking feature 51 is a protrusion or convex body that extends partially through a bend in the second plate 502, and the second locking feature 52 is a protruding pin or convex body. The direction in which the protrusion or convex body extends is opposite to the direction in which the protruding pin or convex body extends, causing the first locking feature 51 to fall along the path from the fourth wall 114 to the positioning means B, at the same time, causing the second locking feature 52 to fall downwards along with the first locking feature 51. The first locking feature 51 is used to lock and unlock relative to the support frame 11, while the second locking feature 52 is used to unlock and lock relative to the slide rail assembly 20, as will be explained later.

Continuing from the above, the slide rail assembly 20 comprises a first rail 21 as the outer frame, a second rail 22 as the inner frame, and a third rail 23 as the middle frame. The third rail 23 is located between the first rail 21 and the second rail 22. The first rail 21 is fixed to the mounting member 41. The second rail 22 is provided with a first unlock feature 221 and/or the third rail 23 is provided with a second unlock feature 231. The first unlock feature 221 is an arc-shaped aperture, and the second unlock feature 231 has an arc-shaped aperture edge corresponding to the arc-shaped aperture of the first unlock feature 221. Therefore, the second locking feature 52 of the auxiliary structure 50 locks or unlocks relative to the first unlock feature 221 and the second unlock feature 231. When the first locking feature 51 is along the path to the fourth wall 114, the second locking feature 52 locks onto the first unlock feature 221 and/or the second unlock feature 231. At this point, the second rail 22 cannot be displaced. When the second locking feature 52 falls down along with the first locking feature 51, the second locking feature 52 is in an unlocked state relative to the first unlock feature 221 and/or the second unlock feature 231. Therefore, the first locking feature 51 is relative to the slide rail device 10 and the second locking feature 52 is relative to the slide rail assembly 20. In addition, the second rail 22 is provided with a guide plate 222, which has a recess I that corresponds to the arc shape of the first unlock feature 221.

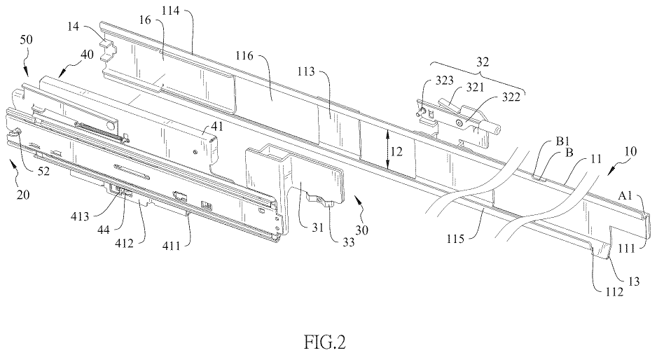

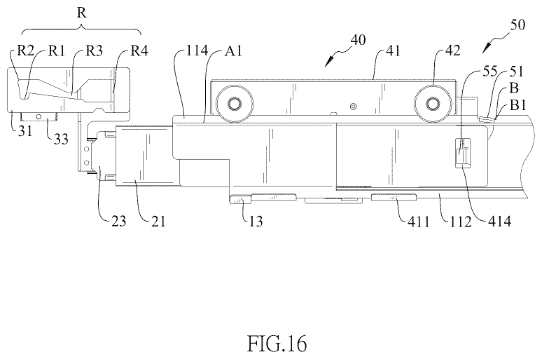

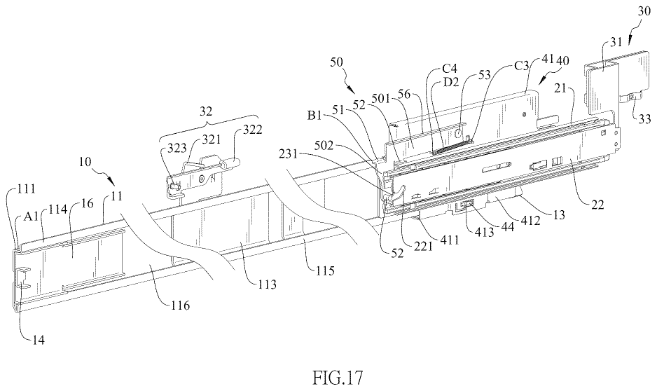

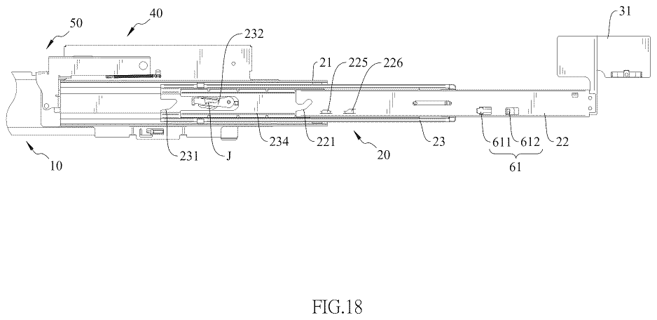

Continuing on, the auxiliary structure 50 is joined to the displacement structure 40, and the join is such that the first plate 501 is pivoted to the mounting member 41. The displacement structure 40 and the auxiliary structure 50 are positioned between the support frame 11 of the slide rail device 10 and the slide rail assembly 20, and a pivot 53 (see FIG. 5) passes through the first plate 501 to the mounting member 41. When the first plate 501 swings, it causes the second plate 502 to swing as well. Referring to FIGS. 2 and 3, a third fixing portion C3 is provided on the first plate 501, and a fourth fixing portion C4 is provided on the mounting member 41 of the displacement structure 40. One end of a second elastic member D2 is connected to the third fixing portion C3, and the other end of the second elastic member D2 is connected to the fourth fixing portion C4. The first locking feature 51 is normally pulled downwards due to the elastic force of the second elastic member D2. Therefore, when it reaches the position corresponding to the positioning means B, the second plate 502 smoothly engages with the positioning means B. In conjunction with the positioning means B, a blocking surface B1 can be constructed (see FIGS. 7 and 15), which can prevent the first locking feature 51 from retracting. The first plate 501 has a first limiting piece 54 at its bottom edge (see FIG. 3), and the second plate 502 has a second limiting piece 55 facing the edge of the first plate 501 (see FIG. 3). The first limiting piece 54 is positioned relative to the slide rail assembly 20 and is used for limiting movement (see FIGS. 14 and 16). The mounting member 41 is provided with a limiting opening 414, and the second limiting piece 55 is limited relative to the limiting opening 414. The first plate 501 has a reinforcing rib 56 on its top edge, so that the auxiliary structure 50 can be stably swaying on the displacement structure 40.

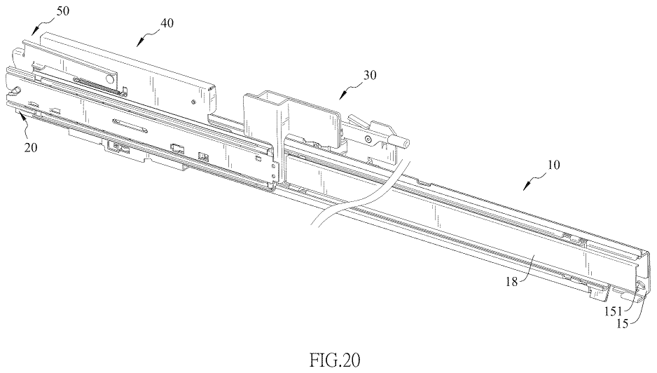

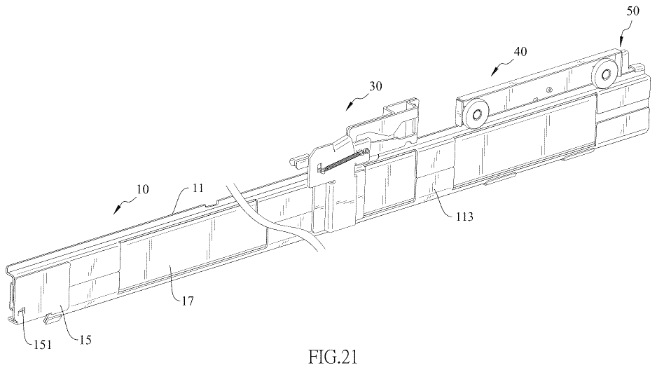

As shown in FIGS. 20 and 21, a first reinforcing frame 15 is provided at the front of the support frame 11. The first reinforcing frame 15 has a hook 151, and the first reinforcing frame 15 can be installed on the longitudinal wall 113 of the support frame 11. The support frame 11 has at least one mounting port 116 (see FIG. 1), and a second reinforcing frame 16 (see FIG. 2) is provided at the rear of the support frame 11, which can be mounted on the mounting port 116. The slide rail device 10 further comprises a fixed rail 17 and at least one movable rail 18 movably connected to the fixed rail 17. The fixed rail 17 and the movable rail 18 are located within the channel 12. If the fixed rail 17 has a protruding feature, the mounting port 116 corresponds to the protruding feature. The components mounted on the movable rail 18 correspond to the hook 151 of the first reinforcing frame 15. Therefore, the support frame 11 effectively integrates the slide rail assembly 20, the fixed rail 17, and the movable rail 18, so that the second rail 22 of the slide rail assembly 20 and the movable rail 18 can be combined with load separately.

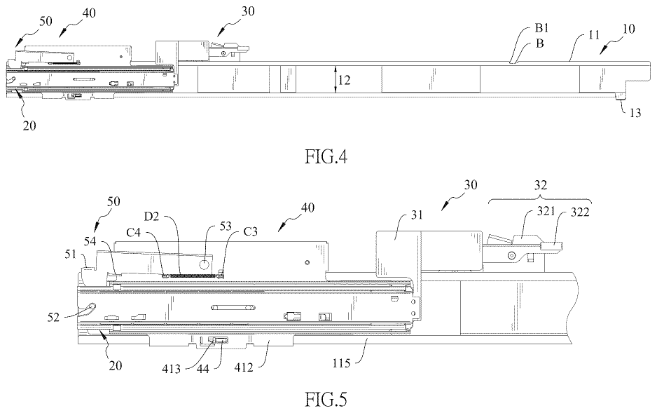

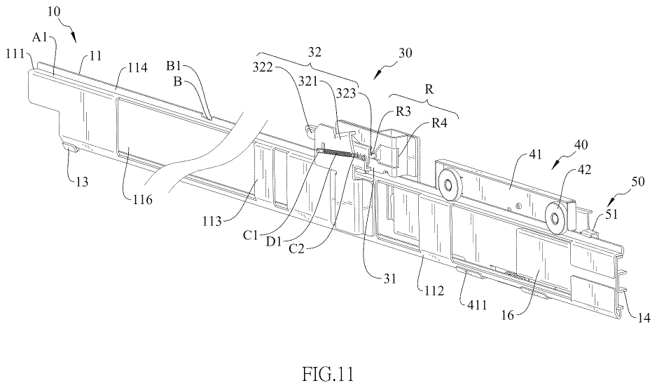

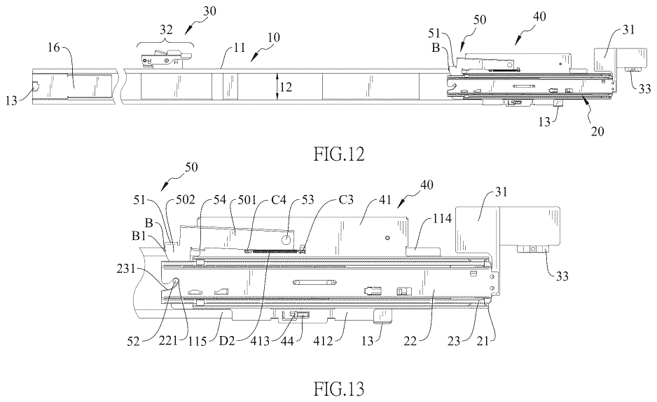

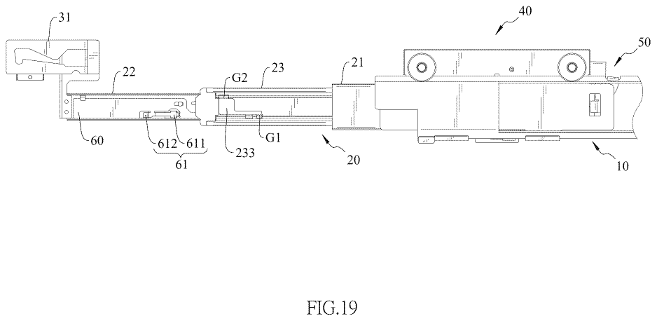

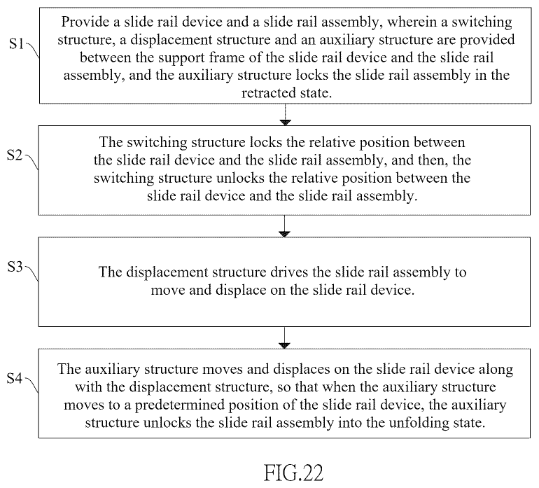

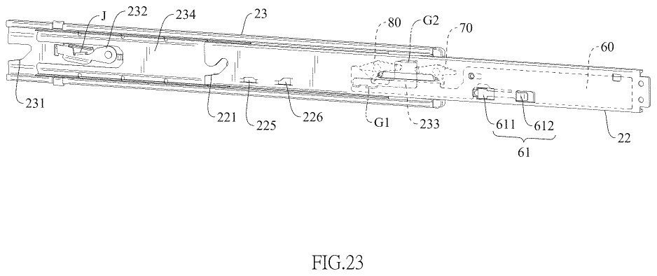

As shown in FIG. 22, an operation method of a slide rail mechanism comprises the following steps:
Step S1: Provide a slide rail device and a slide rail assembly, wherein a switching structure, a displacement structure and an auxiliary structure are provided between the support frame of the slide rail device and the slide rail assembly, and the auxiliary structure locks the slide rail assembly in the retracted state, as shown in FIGS. 1-3.
Step S2: The switching structure locks the relative position between the slide rail device and the slide rail assembly, referring to FIGS. 4-6, and then, the switching structure unlocks the relative position between the slide rail device and the slide rail assembly, referring to FIGS. 7-10.
Step S3: The displacement structure drives the slide rail assembly to move and displace on the slide rail device, as shown in FIGS. 11-14.
Step S4: The auxiliary structure moves and displaces on the slide rail device along with the displacement structure, so that when the auxiliary structure moves to a predetermined position of the slide rail device, as shown in FIGS. 16 and 17, the auxiliary structure unlocks the slide rail assembly into the unfolding state, as shown in FIGS. 18 and 19; conversely, by reversing the operation of the slide rail mechanism, the slide rail assembly can be locked in a retracted state by the auxiliary structure, which will not be described in detail.

As shown in FIGS. 23, 24, 25, and 26, the second rail 22 has an abutment portion 223, and an operating member 60 having a spring leaf 61 with a first portion 611 is provided. When the operating member 60 is operated, the first portion 611 of the spring leaf 61 is engaged with the abutment portion 223, keeping the operating member 60 stationary. In this embodiment, the operating member 60 can be located on the second rail 22 or the third rail 23. The abutment portion 223 has a convex aperture E forming a contact surface E1, and the first portion 611 has a head feature F1 and a wing-shaped feature F2 extending from the head feature F1. The wing-shaped feature F2 abuts against the contact surface E1, which is also the open state of the spring leaf 61.

Continuing from the above, the operating member 60 has a first actuating portion 62 in its middle part and a second actuating portion 63 in its rear part. Operating member 60 can simultaneously activate the spring leaf 61, the first actuating portion 62, and the second actuating portion 63. A first stop member 70 and a second stop member 80 are respectively pivoted to the second rail 22. When the first portion 611 of the spring leaf 61 is engaged with the abutment portion 223, the first actuating portion 62 pushes the first stop member 70 and the second actuating portion 63 pushes the second stop member 80, so that the first stop member 70 remains stationary along with the operating member 60.

Continuing from the above, the spring leaf 61 has a second portion 612 relative to the first portion 611. When the second portion 612 of the spring leaf 61 is activated, the first portion 611 of the spring leaf 61 detaches from the abutment portion 223, causing the operating member 60 to release from remaining stationary. In this embodiment, the second rail 22 has an opening 224 corresponding to the second portion 612 of the spring leaf 61. The second portion 612 of the spring leaf 61 operates within the opening 224, causing the wing-shaped feature F2 to detach from the contact surface E1, which is also the closed state of the spring leaf 61. In this way, the first stop member 70 and the second stop member 80 are released and return to their original state.

Continuing from the above, the third rail 23 is provided with a buckle 233, which has a first stop block G1 and a second stop block G2 of the third rail 23. The first stop block G1 can be hooked onto a bead seat 234, and the second portion 612 of the spring leaf 61 is opposite to the first stop block G1. When the second rail 22 retracts toward the third rail 23, the first stop block G1 can activate the second portion 612 of spring leaf 61. The first stop block G1 or the second stop block G2 can also be set independently on the third rail 23. The two sides of the second stop block G2 are respectively opposite to the first stop member 70 and the second stop member 80. When the first stop member 70 and the second stop member 80 remain stationary along with the operating member 60, the first stop member 70 and the second stop member 80 remain separated from the second stop block G2.

Continuing from the above, when the first actuating portion 62 is pushed against the extension end 71 of the first stop member 70, the front end 72 of the first stop member 70 swings downward, which in turn causes the tail end 73 of the first stop member 70 to swing upward, and at the same time, the second actuating portion 63 can be an inclined plane that pushes the tail end 83 of the second stop member 80 upward, causing the front end 82 of the second stop member 80 to swing downward. Furthermore, when the first actuating portion 62 is pushed against the extension end 81 of the second stop member 80, the front end 82 of the second stop member 80 swings downward, which in turn causes the tail end 83 of the second stop member 80 to swing upward.

Continuing from the above, the second rail 22 is provided with a first release feature 225, which is relative to the first stop block G1. When the second rail 22 retracts and unfolds toward the third rail 23, the first release feature 225 releases the engagement between the first stop block G1 and the bead seat 234.

Continuing from the above, the first rail 21 is provided with a locating member 211 and the third rail 23 is provided with a locking member 232, which is opposite to the locating member 211. When the third rail 23 extends toward the first rail 21, the locking member 232 is positioned on the locating member 211. In this embodiment, the locking member 232 has a hook J and the locating member 211 has a recess K, the fastener J being fastened to the recess K. The second rail 22 is provided with a second release feature 226, which is relative to the locking member 232. When the second rail 22 retracts toward the third rail 23, the second release feature 226 releases the locking member 232 from the locating member 211.

What the invention claimed is:

1. A slide rail mechanism, comprising:
a slide rail device comprising a support frame; said support frame comprising a first wall, a second wall, and a longitudinal wall connecting said first wall and said second wall to form a channel; said first wall comprising a first guide surface; and
a slide rail assembly comprising a displacement structure and an auxiliary structure set on said displacement structure, said displacement structure comprising a mounting member and at least one first rolling member mounted on a top side of said mounting member, said first rolling member comprising a rolling surface, said rolling surface undergoing rolling displacement on said first guide surface to cause said slide rail assembly to move within said support frame of said slide rail device, said auxiliary structure comprising a first locking feature and a second locking feature, said first locking feature being relative to said support frame of said slide rail device, or alternatively said second locking feature being relative to said slide rail assembly.

2. The slide rail mechanism as claimed in claim 1, wherein said slide rail assembly comprises a first rail and a second rail, said first rail being fixed to said mounting member, said second rail comprising a first unlock feature, said second locking feature being to lock or unlock relative to said first unlock feature.

3. The slide rail mechanism as claimed in claim 2, wherein said first unlock feature is an arc-shaped aperture located at a tail end of said second rail, and said second locking feature is a convex body.

4. The slide rail mechanism as claimed in claim 1, wherein said support frame further comprises a fourth wall extending upwards from said first wall, and a positioning means located on said fourth wall; said first locking feature is used to lock or unlock relative to said positioning means.

5. The slide rail mechanism as claimed in claim 4, wherein said positioning means is a notch, and said first locking feature is a convex body.

6. The slide rail mechanism as claimed in claim 4, wherein said support frame further comprises a fourth wall extending upwards from said first wall, and a fifth wall extending upward from said second wall to form a V-shaped barb shape; each said first rolling member has a side surface holding said fourth wall, such that said fourth wall is positioned between the said side surface of each said first rolling member and said mounting member.

7. The slide rail mechanism as claimed in claim 6, wherein said fifth wall comprises a second guide surface for facing said mounting member; said mounting member comprises at least one third rolling member located on one side surface thereof, each said third rolling member having a rolling surface that rolls and displaces on said second guide surface.

8. The slide rail mechanism as claimed in claim 1, wherein said support frame further comprises a fourth wall extending upwards from said first wall, and a fifth wall extending downwards and outwards from said second wall to show an L-shaped cross section; each said first rolling member has a side surface holding said fourth wall, such that said fourth wall is positioned between the said side surface of each said first rolling member and said mounting member; said mounting member comprises a bottom holding wall holding said second wall.

9. The slide rail mechanism as claimed in claim 8, wherein said fifth wall comprises a second guide surface for facing said mounting member; said mounting member comprises at least one third rolling member located on one side surface thereof, each said third rolling member comprising a rolling surface that rolls and displaces on said second guide surface.

10. The slide rail mechanism as claimed in claim 1, wherein said support frame further comprises a fourth wall extending upwards from said first wall, a fifth wall extending upwards from said second wall, and a third guide surface located on said second wall; each said first rolling member has a side surface holding said fourth wall, such that said fourth wall is positioned between the said side surface of each said first rolling member and said mounting member; said mounting member comprises at least one second rolling member mounted on a bottom side thereof, each said second rolling member comprising a side surface thereof holding said fifth wall, such that said fifth wall is positioned between the said side surface of each said second rolling member and said mounting member, each said second rolling member comprising a rolling surface that rolls and displaces on said third guide surface.

11. The slide rail mechanism as claimed in claim 1, wherein said slide rail assembly comprises a first rail, a second rail and a third rail, said third rail being relative to said first rail and said second rail being relative to said third rail, said first rail being fixed to said mounting member, said second rail comprising a first unlock feature, said second locking feature being used to lock or unlock relative to said first unlock feature.

12. The slide rail mechanism as claimed in claim 11, wherein said third rail comprises a second unlock feature corresponding to said first unlock feature, and said second locking feature being used to lock or unlock relative to said first unlock feature and said second unlock features.

13. The slide rail mechanism as claimed in claim 1, wherein said support frame further comprises a first reinforcing frame at a front thereof, said first reinforcing frame comprising a hook, and said first reinforcing frame being installed on said longitudinal wall of said support frame.

14. The slide rail mechanism as claimed in claim 1, wherein said support frame further comprises a first stop located at a front side thereof and a second stop located at a rear side thereof; said slide rail assembly is limited between said first stop and said second stop.

15. The slide rail mechanism as claimed in claim 1, wherein said support frame further comprises at least one mounting port, and a second reinforcing frame located at a rear side thereof and mountable on said at least one mounting port.

16. The slide rail mechanism as claimed in claim 1, wherein said slide rail device comprises a fixed rail and at least one movable rail movably connected to said fixed rail, said fixed rail and said at least one movable rail being mounted in said channel.

17. The slide rail mechanism as claimed in claim 1, further comprising a switching structure, said switching structure comprising a path plate and a guide device opposite to said path plate, one of said path plate and said guide device being disposed in said slide rail assembly and the other of said path plate and said guide device being disposed in said support frame of said slide rail device, such that when said path plate is located on said slide rail assembly, said guide device is located on said slide rail device, alternatively, when said path plate is located on said slide rail device, then said guide device is located on said slide rail assembly, so that said guide device locks or unlocks said path plate, and said slide rail assembly is locked or unlocked on said slide rail device.

18. The slide rail mechanism as claimed in claim 17, wherein said path plate comprises a path; said guide device comprises a bracket, a handle pivoted to said bracket and a guide block located on said handle, said guide block being used to perform locking or unlocking on said path.

19. The slide rail mechanism as claimed in claim 18, wherein said path comprises a locking groove, a limiting arc, a narrow slit and a differential opening, said locking groove extending vertically, said narrow slit being horizontally narrowed between said limiting arc and said differential opening.

20. A slide rail mechanism, comprising:
a slide rail device comprising a support frame; said support frame comprising a first wall, a second wall, a longitudinal wall connecting said first wall and said second wall to form a channel, a first guide surface located on said first wall, a fourth wall extending upwards from said first wall, and a positioning means located on said fourth wall; and
a slide rail assembly comprising a displacement structure, an auxiliary structure set on said displacement structure, a first rail, a second rail and a third rail, said third rail being relative to said first rail and said second rail being relative to said third rail, said second rail comprising a first unlock feature, said displacement structure comprising a mounting member and at least one first rolling member mounted on a top side of said mounting member, said first rail being fixed to said mounting member, said first rolling member comprising a rolling surface, said rolling surface undergoing rolling displacement on said first guide surface to cause said slide rail assembly to move within said support frame of said slide rail device, said auxiliary structure comprising a first locking feature and a second locking feature so arranged that when said first locking feature is locked to said positioning means, said second locking feature is unlocked to said first unlock feature; or when said second locking feature is locked to said first unlock feature, said first locking feature is unlocked to said positioning means.
